(19) United States
(12) Patent Application Publication
(10) Pub. No.: US 2015/0140329 A1
(43) Pub. Date: May 21, 2015

(54) ADHESIVE TAPE FOR USE WITH PAINTS HAVING LOW OR NO VOLATILE ORGANIC COMPOUNDS

(71) Applicant: SHURTAPE TECHNOLOGIES, LLC, Hickory, NC (US)

(72) Inventors: Nilufer Tanrikulu, Denver, NC (US); Windy Kathalikkatil, Denver, NC (US)

(73) Assignee: SHURTAPE TECHNOLOGIES, LLC, Hickory, NC (US)

(21) Appl. No.: 14/294,546

(22) Filed: Jun. 3, 2014

Related U.S. Application Data
(60) Provisional application No. 61/907,081, filed on Nov. 21, 2013.

(51) Int. Cl. C09J 7/02; C09J 193/04; C09J 5/00; C09J 7/04

(52) U.S. Cl. CPC C09J 7/0207; C09J 7/045; C09J 7/046; C09J 193/04; C09J 7/0214; C09J 5/00; C09J 2201/606; C09J 2203/31; C09J 2493/00; C09J 2201/122; C09J 2421/00; C09J 2400/283
USPC 428/352; 428/355 R; 428/354; 530/210; 106/218; 524/270; 156/326

(57) ABSTRACT

An adhesive tape comprising a substrate having a top surface and a bottom surface, and an adhesive applied to the top or the bottom surface of the substrate. The adhesive comprises a tackifying resin. The tackifying resin comprises a rosin resin, a rosin resin derivative, a terpene resin, a heat reactive phenolic resin, a petroleum-based resin, or a combination thereof. Rosin resin derivatives include a rosin ester, a rosin metal salt, a hydrogenated rosin ester, a partially hydrogenated rosin, or a combination thereof. In another aspect, the adhesive is a pressure sensitive adhesive, and the adhesive tape is a masking tape. The adhesive tape is particularly suitable for adhesion to surfaces painted with paint having low or no volatile organic compounds.

### CROSS-REFERENCE TO RELATED APPLICATIONS

This application claims priority from U.S. patent application Ser. No. 61/907,081, filed on Nov. 21, 2013, in the United States Patent and Trademark Office. The disclosure of which is incorporated herein by reference in its entirety.

### FIELD OF THE INVENTION

The present invention relates to an adhesive tape for use with paint having low or no volatile organic compounds (VOCs), particularly to a pressure sensitive adhesive tape.

### BACKGROUND OF THE INVENTION

Volatile organic compounds (VOCs) are organic chemicals that evaporate and enter the surrounding air at various rates based on their vapor pressure and corresponding boiling point. For instance, VOCs in paints are solvents, alcohols, glycols, glycol ethers and similar compounds known to the industry.

There is a growing concern among the public as some VOCs have short-term or long-term adverse health effects. The concentration of VOCs is even greater indoors than outdoors. VOCs are emitted by a wide variety of household and industrial products such as paints, lacquers, paint strippers, cleaning products, pesticides, building materials, office equipment and supplies, craft materials, among others.

There are essential ingredients in water-based paints considered as VOCs such as coalescent agents that are important for film forming and for affecting the flow and open time of paints, glycols that are important for substrate wetting and lower freezing temperature, some rheology additives that are important for adjusting the paint viscosity, surfactants that are important for stability, and biocides that are used to eliminate bacterial growth.

Paint manufacturers have been reducing the VOC content of water-based paints without compromising paint performance issues in the marketplace. Paint manufacturers have been replacing VOC containing materials to offer safer alternatives. Tough VOC limits have been adopted to alleviate the environmental impact of those compounds and resulting health issues.

Adhesive tapes have historically been used for painting applications to mask areas that need to be protected. Painters grade masking tapes have developed and evolved over the years. A painters grade masking tape should adhere to a substrate until the painting job is completed then should be removed without leaving any residue and surface damage. Generally, water-based latex paints and some oil-based or solvent-based paints are used for interior house painting. The adhesive systems for such tapes have been formulated to eliminate adhesive residue and/or surface damage and withstand ultraviolet (UV) light for indoor and outdoor applications.

There are different chemistries being utilized in the adhesive formulations based on the end-use requirements and the types of substrates to which tapes are being applied such as wall board, wood or metal. Many of such retail products suggest tape application days to guide consumers to make a proper choice based on their needs. The adhesion level information of a tape can be found in the packaging as, for example, low, medium, and high or intermediate levels.

At the present time, pressure sensitive adhesive (PSA)-containing painters grade masking tapes have issues with adherence to low VOC and no VOC paints, especially when the paint is freshly applied. The PSA tapes typically fall off from the freshly painted surfaces and do not mask the protected areas during painting. This presents a problem as painters need PSA tapes to get satisfactory results.

Thus, there is a need for an adhesive tape, particularly a pressure sensitive adhesive tape, that can be used in environments or with products, such as paints, that have traditionally used VOCs but now contain no or low levels of VOCs.

### SUMMARY OF THE INVENTION

The present invention relates to an adhesive tape, particularly a pressure sensitive adhesive tape, that can be used with paint containing no or low levels of VOCs.

In an aspect of the invention, the adhesive tape comprises a substrate having a top surface and a bottom surface, and an adhesive applied to the top or the bottom surface of the substrate. The adhesive comprises a tackifying resin and the tackifying resin comprises a rosin resin, a rosin resin derivative, a terpene resin, a heat reactive phenolic resin, a petroleum-based resin, or a combination thereof. The rosin resin derivative is a rosin ester, a rosin metal salt, a hydrogenated rosin ester, a partially hydrogenated rosin, or a combination thereof.

In another aspect of the invention, the adhesive is a pressure sensitive adhesive, and the adhesive tape is a masking tape.

In another aspect of the invention, the adhesive tape is a duct tape.

The present invention relates to a method of making an adhesive formulation comprising adding a rosin resin, a rosin resin derivative, a terpene resin, a heat reactive phenolic resin, a petroleum-based resin, or a combination thereof to a synthetic rubber.

The present invention also relates to a method of using an adhesive tape. The method comprises obtaining an adhesive tape a having an adhesive formulation applied thereon, and the adhesive formulation comprises a tackifying resin. The tackifying resin comprises a rosin resin, a rosin resin derivative, a terpene resin, a heat reactive phenolic resin, a petroleum-based resin, or a combination thereof. The method further comprises applying the adhesive tape to a surface having been painted with a paint having low or no volatile organic compounds.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 illustrates adhesion to ProMar 200 Eggshell paint of Sherwin-Williams.

FIG. 2 illustrates adhesion to ProMar 200 No VOC Eggshell paint of Sherwin-Williams.

FIG. 3 illustrates adhesion to painted wood (two coats).

### DETAILED DESCRIPTION OF THE INVENTION

The following detailed description of the embodiment(s) is merely exemplary in nature and is in no way intended to limit the invention, its application, or uses.

The present invention relates to a tape having a substrate and an adhesive system that is suitable for use with low or no VOC paint. The adhesive formulation of the adhesive tape of the present invention addresses the issue of PSA tape falling off from freshly painted surfaces.

The tape substrate has a top surface and a bottom surface. An adhesive formulation is applied to the top or bottom surface of the tape. In some instances, the tape may have an optional layer that is impervious or at least resistant to liquids on the surface opposing the adhesive treated surface. The tape is most often wound on a core to form a roll. A liner layer may optionally be applied to the adhesive treated surface of the tape.

The substrate may be a paper, film, polymer or other material. Examples of papers include, but are not limited to, crepe paper, washi paper and kraft paper. An example of crepe paper is a fine structured crepe paper. Paper should be impregnated with a saturant to improve strength and then release coated on one side, which is opposite of adhesive side. Examples of film tape backing materials include, but are not limited to, polypropylene, polyester, polyethylene homopolymers and copolymers thereof.

The adhesive system of the present invention creates a stronger bond with the freshly painted surfaces than other PSA adhesive systems.

The adhesive of the adhesive tape may be any suitable adhesive composition, e.g. a pressure sensitive adhesive. Examples of suitable pressure sensitive adhesives include, but are not limited to, acrylics, butyl rubber, ethylene vinyl acetate, hot melt, natural rubber, nitriles, silicone rubbers, styrenic block copolymers (SBC), microsphere, synthetic rubber, and polyurethane (PU) adhesives.

In accordance with the present invention, the pressure sensitive adhesive system comprises a tackifying resin. In a preferred aspect of the present invention, the adhesive system is a synthetic block copolymer system comprising a tackifying resin.

In a preferred aspect of the present invention, the tackifying resin is a rosin resin. A rosin resin may be, but is not be limited to, gum rosin, wood rosin, tall oil rosin, or a combination thereof. The rosin resin can be stabilized with hydrogenation, disproportionation and polymerization to exhibit high resistance to oxidation. In a preferred aspect of the invention, the resin is partially hydrogenated gum resin.

Rosin acids react with a variety of alcohols to form rosin esters. Rosin esters may be used in the adhesive formulations of the present invention. An example of a commercially available rosin ester is Foral 105-E from Eastman. Rosin acid metal salts may be used in the adhesive formulations of the present invention. An example of a commercially available rosin acid metal salt is Resizinc-155 from T&R Chemicals. Another group of resins that may be present in the adhesive formulations of the present invention is terpene resins. Terpene phenolic resins, for example, have broad polymer compatibility and may be used in the adhesive formulations of the present invention to, for example, improve peel adhesion performance.

The percentage of the rosin tackifying resin in the total resin is in a range of from 1% to 100%, preferably from 15% to 93%.

In accordance with the present invention, a method of making the adhesive tape is set forth herein. The method comprises adding a tackifying resin to an adhesive. More particularly, the method comprises adding a tackifying resin to a synthetic block copolymer adhesive. The method further comprises applying the adhesive to a surface of the substrate thereby forming an adhesive tape.

The adhesive tape of the present invention has a greater adhesion level to a surface painted with a paint having low or no volatile organic compounds than an adhesive tape having an adhesive without a rosin, a rosin derivative, a terpene resin, a heat reactive phenolic resin, a petroleum-based resin, or a combination thereof.

### Example 1

### Adhesive Formulations

A tackifying resin was selected for use in the adhesive formulations. The tackifying resin was a partially hydrogenated gum rosin. Resin H was a partially hydrogenated gum rosin from T&R Chemicals Inc. It had an Acid Number minimum 158. The softening point of the resin was 68-75° C. with a light color.

The resin's acid functionality was neutralized with Zinc Oxide Active #35; however, toluene sulfonic acid increased the acidic nature of Resin H before neutralizing it with Zinc Oxide Active #35. Wingtack 98 is a straight C 5 hydrocarbon resin (petroleum-based) from Cray Valley. Quintac 3620 and Quintac 3520 are thermoplastic rubbers from Zeon Chemicals. Wingstay L from Omnova Solutions is a hindered phenolic antioxidant to protect the adhesive from degradation.

TABLE 1

| | | Adhesive | Adhesive | Adhesive | Adhesive | Adhesive | Adhesive |
|---|---|---|---|---|---|---|---|
| | Material | Formulation | Formulation | Formulation | Formulation | Formulation | Formulation |
| Material | Type | 1 | 2 | 3 | 4 | 5 | 6 |
| Toluene | Solvent | 203.5 | 216.94 | 216.94 | 216.94 | 216.94 | 216.94 |
| Resin H* | Partially | 0 | 10 | 20 | 40 | 50 | 60 |
| | Hydrogenated | | | | | | |
| | Rosin | | | | | | |
| Toluene | Acid | 0 | 1 | 1 | 1 | 1 | 1 |
| Sulfonic | | | | | | | |
| Acid | | | | | | | |
| ZINKOXYD | zinc oxide | 0 | 10 | 10 | 10 | 12.5 | 15 |
| AKTIV | | | | | | | |
| #35 | | | | | | | |
| QUINTAC | SIS | 75 | 75 | 75 | 75 | 75 | 75 |
| 3620 | | | | | | | |
| QUINTAC | SIS | 25 | 25 | 25 | 25 | 25 | 25 |
| 3520 | | | | | | | |
| WINGSTAY | Antioxidant | 1.5 | 1.5 | 1.5 | 1.5 | 1.5 | 1.5 |
| “L” | | | | | | | |
| Wingtack | Aliphatic | 65 | 55 | 45 | 25 | 15 | 5 |
| 98 | Resin | | | | | | |
| Total Resin | | 65 | 65 | 65 | 65 | 65 | 65 |
| (g) | | | | | | | |
| Total Dry | | 166.5 | 177.5 | 177.5 | 177.5 | 180 | 182.5 |
| Content (g) | | | | | | | |
| % Resin H | | 0.00% | 15.38% | 30.77% | 61.54% | 76.92% | 92.31% |
| in Total | | | | | | | |
| Resin | | | | | | | |

*Amount of resin is in grams (g)

The adhesive formulations in Table 1 were prepared by dissolving the ingredients in solvent, which was a technical grade solvent. These formulations were pilot coated on 47.1 lb/rm Fine Structured Crepe (FSC) paper, which was previously saturated and release coated with a target adhesive dry weight of 1.1 oz/sqyd.

The formulations were tested in a Physical Test Lab for the following physical properties set forth in Table 2.

TABLE 2
Physical Properties of Tested Tapes

| Physical | | | | | | | |
|---|---|---|---|---|---|---|---|
| Properties | Units | 1 | 2 | 3 | 4 | 5 | 6 |
| Adhesion | oz./in | 35.4 | 33.0 | 32.2 | 34.8 | 38.2 | 38.5 |
| to Steel | | | | | | | |
| Adhesion | oz./in | 13.6 | 13.0 | 13.2 | 14.8 | 15.3 | 14.6 |
| to | | | | | | | |
| Backing | | | | | | | |
| Adhesion | oz./in | 21.4 | 19.4 | 19.8 | 23.0 | 22.7 | 22.7 |
| to Kraft | | | | | | | |
| 90 | oz./in | 13.8 | 13.9 | 15.5 | 18.5 | 19.9 | 20.6 |
| Degree | | | | | | | |
| Quick | | | | | | | |
| stick | | | | | | | |
| Unwind- | oz./in | 8.0 | 8.0 | 7.0 | 7.2 | 6.3 | 7.0 |
| 100 fpm | | | | | | | |
| Rolling | in | 0.9 | 0.9 | 0.8 | 0.8 | 0.9 | 1.0 |
| Ball tack | | | | | | | |
| Total | oz./yd2 | 3.45 | 3.46 | 3.44 | 3.45 | 3.50 | 3.49 |
| Weight | | | | | | | |
| Backing | oz./yd2 | 2.42 | 2.52 | 2.52 | 2.42 | 2.42 | 2.44 |
| Weight | | | | | | | |
| Adhesive | oz./yd2 | 1.03 | 0.94 | 0.92 | 1.03 | 1.08 | 1.05 |
| Weight | | | | | | | |
| Tape | mils | 7.0 | 6.9 | 6.9 | 7.0 | 7.1 | 7.0 |
| Thickness | | | | | | | |
| Aged | oz./in | 26.1 | 26.3 | 25.7 | 28.4 | 30.1 | 31.1 |
| Adhesion | | | | | | | |
| to Steel | | | | | | | |
| Aged | oz./in | 14.3 | 12.9 | 13.8 | 15.5 | 16.2 | 14.6 |
| Adhesion | | | | | | | |
| to | | | | | | | |
| Backing | | | | | | | |
| Aged | oz./in | 15.2 | 15.0 | 14.5 | 17.8 | 20.2 | 21.0 |
| Adhesion | | | | | | | |
| to Kraft | | | | | | | |
| Aged 90 | oz./in | 9.6 | 8.9 | 9.6 | 12.1 | 12.4 | 14.0 |
| Degree | | | | | | | |
| Quick | | | | | | | |
| stick | | | | | | | |
| Aged | oz./in | 39.5 | 33.5 | 34.5 | 35.5 | 36.0 | 39.0 |
| Unwind- | | | | | | | |
| 100 fpm | | | | | | | |
| Aged | in | 1.2 | 1.5 | 1.4 | 1.4 | 1.4 | 1.9 |
| Rolling | | | | | | | |
| Ball Tack | | | | | | | |

These tapes were tested for performance on freshly painted surfaces, since adhesion to the freshly painted surfaces was an important testing criteria. The wood panels were prepared by cutting the wood panels 2″×6″ and then coating with two coats of paint a) ProMar 200 eggshell (standard) and b) ProMar 200 No VOC eggshell finish. The adhesions were measured after the paint had four hours and twenty-four hours to dry at standard lab conditions of 72° F., 60% Relative Humidity.

Tape paint adhesion values were important for the masking applications. Generally, kraft masking paper or polyethylene tarp have been hung with the masking tape for larger surface protection. The masking tape was to have enough adhesion and cohesive strength to stay on the substrates.

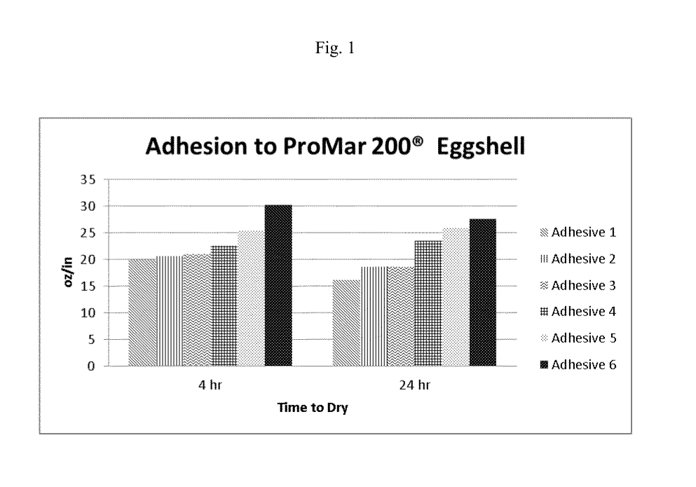

Adhesion to ProMar 200 Eggshell (standard paint) is seen in FIG. 1.

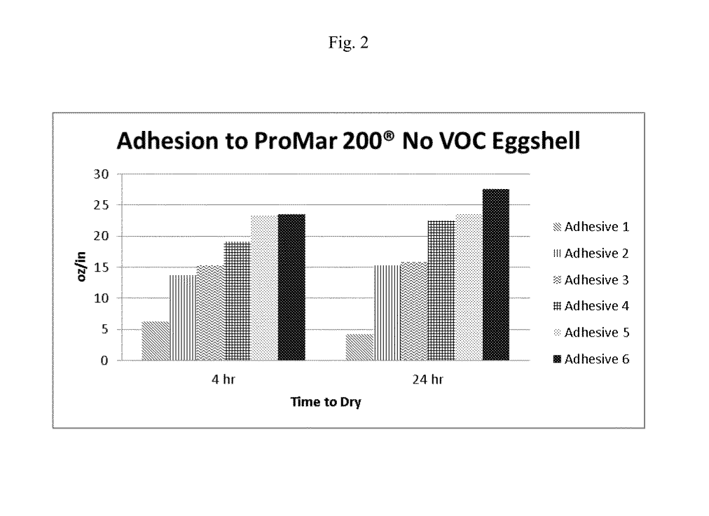

Adhesion to ProMar 200 No VOC Eggshell paint is seen in FIG. 2.

The adhesives 1 through 6 have 65 phr tackifying resin level kept constant. The adhesion to steel value went up slightly with increasing Resin H level from 10 phr to 60 phr (See Table 2). FIG. 1 shows slightly increased adhesion to ProMar 200 with increased Resin H content. As seen in the results, 4 hrs paint drying time versus 24 hours paint drying time did not affect the paint adhesion numbers significantly. Adhesive 1 without the Resin H had sufficient paint adhesion greater than 15 oz/in on ProMar 200 paint, which is important for PSA tape to function for masking applications.

However, FIG. 2 shows a significant increase in paint adhesions to the ProMar 200 No VOC paint with addition of 10 phr Resin H (15.38% of total tackifying resin). Resin H addition increased the paint adhesions more than double on the ProMar 200 No VOC and it brought them to a comparable adhesion level with ProMar 200, which is not claimed as Low or No VOC content. Adhesive 1 without Resin H had very low paint adhesion to ProMar 200 No VOC paint; the PSA tape might fall off from the surface since the adhesion level was too low at less than 10 oz/in.

Adhesive formulation 4 had the optimized paint adhesion level for ProMar 200 Eggshell and ProMar 200 No VOC Eggshell paints. It functioned very well for the paint masking applications. The optimum adhesion level was 20 to 25 oz/in.

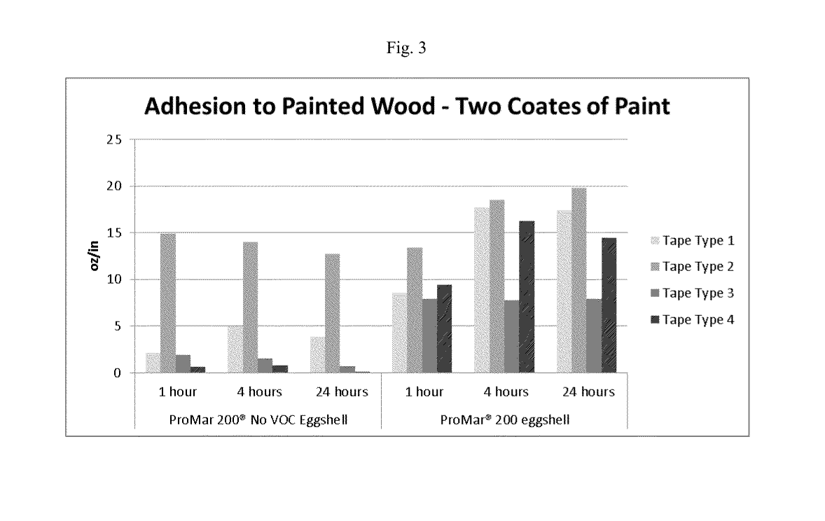

Paint masking applications on painted wood were tested. The results are shown in FIG. 3. FIG. 3 illustrates adhesion to painted wood (two coats).

Several PSA tape paint adhesions were measured on above mentioned paint types a) ProMar 200 eggshell and b) ProMar 200 no VOC eggshell. The wood panels (2″×6″) were painted and dried 1 hour, 4 hours and 24 hours before the tape application.

Tape type 1: Synthetic Rubber/Aliphatic resin/Napthenic oil

Tape type 2: Synthetic Rubber/Resin H/Aliphatic resin

Tape type 3: Acrylic PSA

Tape type 4: Synthetic Rubber/Hydrogenated Resin/Aliphatic Resin

As can be seen from the results, there are significantly higher paint adhesions observed with Tape type 2 on ProMar 200 No VOC eggshell paint; other Tape types 1, 3, and 4 had much lower paint adhesion levels on that paint.

Tape type 2 had comparable adhesion level with other synthetic rubber based adhesive types on freshly painted ProMar 200 eggshell, which is not claimed as low or no VOC. Acrylic PSA seemed like lower paint adhesion level than any synthetic rubber based types under the same conditions.

Tape type 2 had the adhesive formulation #4 (Table 1) formulated as a removable painters masking tape measured 13 oz/in to 23 oz/in paint adhesion to freshly painted surfaces.

Adhesive 4 formulated with 40 phr Resin H (61.54% total resin), which is a partially hydrogenated rosin with a minimum acid number of 158 used as a tackifying resin, seemed to improve PSA tape adhesions on freshly painted surfaces. Resin H amount in the total resin varied from 15.4% to 92.3% without compromising the paint adhesion levels.

It is contemplated and within the scope of the present invention that the resin system of this invention may be used with other adhesive tapes having different adhesive systems, such as duct tapes, to likewise adhere to painted surfaces having no or low VOC content. For example, using zinc resinate (rosin acid metal salts) as part of tackifying resin may improve duct tape adhesion to low VOC and no VOC paints. An example of a commercially available zinc resinate (rosin acid metal salts) is Resizinc-155 from T&R Chemicals.

The adhesive tape of the present invention may be used in many different masking applications, including, but not limited to painting, staining, glazing, shellacking, varnishing, lacquering, cleaning, and stripping. The adhesive tape of the present invention may be used on textured and non-textured surfaces.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. An adhesive tape comprising:
a substrate having a top surface and a bottom surface, and
an adhesive applied to the top or the bottom surface of the substrate, wherein the adhesive comprises a tackifying resin and the tackifying resin comprises a rosin resin, a rosin resin derivative, a terpene resin, a heat reactive phenolic resin, a petroleum-based resin, or a combination thereof.

2. The adhesive tape according to claim 1, wherein the rosin resin derivative is a rosin ester, a rosin metal salt, a hydrogenated rosin ester, a partially hydrogenated rosin, or a combination thereof.

3. The adhesive tape according to claim 2, wherein the rosin metal salt is calcium resinate, zinc resinate, or a combination thereof.

4. The adhesive tape according to claim 1, wherein the terpene resin is a terpene phenolic resin.

5. The adhesive tape according to claim 1, wherein the adhesive is a pressure sensitive adhesive.

6. The adhesive tape according to claim 1, wherein the adhesive tape is a masking tape.

7. The adhesive tape according to claim 1, further comprising a liner applied to the adhesive.

8. The adhesive tape according to claim 1, wherein the substrate is a paper, film, polymer or other material.

9. The adhesive tape according to claim 8, wherein the paper is crepe paper, washi paper, or kraft paper.

10. The adhesive tape according to claim 9, wherein the kraft paper is impregnated with a saturant and release coated on one side which is opposite of adhesive.

11. The adhesive tape according to claim 1, wherein the rosin resin is a gum rosin, wood rosin, tall oil rosin, or a combination thereof.

12. The adhesive tape according to claim 1, wherein the rosin resin is a partially hydrogenated gum resin.

13. The adhesive tape according to claim 1, wherein the rosin is stabilized with hydrogenation, disproportionation, polymerization, or a combination thereof.

14. The adhesive tape according to claim 1, wherein the rosin resin is present in a range of 1% to 100% of a total amount of tackifying resin.

15. The adhesive tape according to claim 14, wherein the rosin resin is present in a range of 15% to 93% of a total amount of tackifying resin.

16. The adhesive tape according to claim 1, wherein the rosin has an acid number of 158.

17. The adhesive tape according to claim 1, wherein the adhesive tape has a greater adhesion level to a surface painted with a paint having low or no volatile organic compounds than another adhesive tape having an adhesive without a rosin resin, a rosin resin derivative, a terpene resin, a heat reactive phenolic resin, a petroleum-based resin, or a combination thereof.

18. An adhesive tape comprising:
a substrate having a top surface and a bottom surface, and
an adhesive, wherein the adhesive formulation comprises a tackifying resin and the tackifying resin comprises a rosin, a rosin derivative, a terpene resin, a petroleum-based resin, or a combination thereof.

19. The adhesive tape according to claim 18, wherein the adhesive tape is a duct tape.

20. The adhesive tape according to claim 18, wherein the rosin resin derivative is a rosin ester, a rosin metal salt, a hydrogenated rosin ester, a partially hydrogenated rosin, or a combination thereof.

21. The adhesive tape according to claim 20, wherein the rosin metal salt is calcium resinate, zinc resinate, or a combination thereof.

22. The adhesive tape according to claim 18, wherein the terpene resin is a terpene phenolic resin.

23. The adhesive tape according to claim 18, wherein the rosin resin is a gum rosin, wood rosin, tall oil rosin, or a combination thereof.

24. The adhesive tape according to claim 18, wherein the rosin resin is a partially hydrogenated gum resin.

25. The adhesive tape according to claim 18, wherein the substrate is a paper, film, polymer or other material.

26. The adhesive tape according to claim 18, wherein the adhesive tape has a greater adhesion level to a surface painted with a paint having low or no volatile organic compounds than another adhesive tape having an adhesive without a rosin, a rosin derivative, a terpene resin, a petroleum-based resin, or a combination thereof.

27. An adhesive formulation comprising a tackifying resin, wherein the tackifying resin comprises a rosin resin, a rosin resin derivative, a terpene resin, a heat reactive phenolic resin, a petroleum-based resin, or a combination thereof.

28. The adhesive formulation according to claim 27, wherein the rosin resin derivative is a rosin ester, a rosin metal salt, a hydrogenated rosin ester, a partially hydrogenated rosin, or a combination thereof.

29. The adhesive formulation according to claim 27, wherein the terpene resin is a terpene phenolic resin.

30. The adhesive formulation according to claim 28, wherein the rosin metal salt is calcium resinate or zinc resinate.

31. The adhesive formulation according to claim 27, wherein the rosin resin is a partially hydrogenated gum resin.

32. The adhesive formulation according to claim 27, wherein the rosin is stabilized with hydrogenation, disproportionation, polymerization, or a combination thereof.

33. The adhesive formulation according to claim 27, wherein the rosin resin is present in a range of 1% to 100% of a total amount of tackifying resin.

34. The adhesive formulation according to claim 27, wherein the rosin resin is present in a range of 15% to 93% of a total amount of tackifying resin.

35. The adhesive formulation according to claim 27, wherein the rosin resin has a softening point of 68° C. to 75° C.

36. A method of making the adhesive formulation comprising:
adding a rosin resin, a rosin resin derivative, a terpene resin, a heat reactive phenolic resin, a petroleum-based resin, or a combination thereof to a synthetic rubber.

37. The method of making according to claim 36, wherein the rosin resin derivative is derivative is a rosin ester, a rosin metal salt, a hydrogenated rosin ester, a partially hydrogenated rosin, or a combination thereof.

38. The method of making according to claim 36, wherein the rosin metal salt is calcium resinate, zinc resinate, or a combination thereof.

39. The method of making according to claim 36, wherein the terpene resin is a terpene phenolic resin.

40. A method of using an adhesive tape, the method comprising:
obtaining an adhesive tape a having an adhesive formulation applied thereon, wherein the adhesive formulation comprises a tackifying resin and the tackifying resin comprises a rosin resin, a rosin resin derivative, a terpene resin, a heat reactive phenolic resin, a petroleum-based resin, or a combination thereof,
and applying the adhesive tape to a surface having been painted with a paint having low or no volatile organic compounds.

41. The method of using according to claim 40, wherein the rosin resin derivative is a rosin ester, a rosin metal salt, a hydrogenated rosin ester, or a combination thereof.

42. The method of using according to claim 41, wherein the rosin metal salt is calcium resinate, zinc resinate, or a combination thereof.

43. The method of using according to claim 40, wherein the terpene resin is a terpene phenolic resin.
